(19) United States
(12) Patent Application Publication
(10) Pub. No.: US 2013/0286909 A1
(43) Pub. Date: Oct. 31, 2013

(54) SYSTEM AND METHOD FOR REDUCING POWER CONSUMPTION IN A WIRELESS COMMUNICATION SYSTEM

(71) Applicants: Sivakumar PANNEERSELVAM, Chennai (IN); Simone MERLIN, Solano Beach, CA (US)

(72) Inventors: Sivakumar PANNEERSELVAM, Chennai (IN); Simone MERLIN, Solano Beach, CA (US)

(73) Assignee: QUALCOMM ATHEROS, INC., San Jose, CA (US)

(21) Appl. No.: 13/457,296

(22) Filed: Apr. 26, 2012

(51) Int. Cl. H04W 52/02; H04W 72/04

(52) U.S. Cl. 370/311

(57) ABSTRACT

In a wireless communication system an access point and a station in association with the access point, the station is configured to transmit keep alive information to the access point regarding a period of time during which the station will be in a low power mode. The access point is configured to maintain the association with the station for the period of time even when no communications are received from the station during the period of time. The keep alive information is configured to allow designation of a period of time greater than 18 hours.

### FIELD OF THE PRESENT INVENTION

This disclosure generally relates to wireless communication systems and more specifically to systems and methods for reducing power consumption by facilitating extended sleep intervals for client devices.

### BACKGROUND OF THE INVENTION

Wireless networks are increasingly employed to provide various communication functions including voice, video, packet data, messaging and the like. A wireless network such as wireless local area networks (WLANs) may include any number of access points (APs) and any number of stations (STAs). An access point may act as a coordinator for communication with the stations. A station may actively communicate with an access point, may be idle, or may be powered down at any given moment depending on the data requirements of the station. Particularly with regard to mobile devices and other devices that are battery powered, minimizing energy consumption is an important aspect in the design of such systems. To that end, wireless communication systems typically include various power saving techniques that generally seek to increase the amount of time spent in a low power mode.

For example, within the WEE 802.11 standards established by The Institute of Electrical and Electronics Engineers are provisions to allow a station to enter a low power mode of operation, also known as sleep mode, to save power. An access point periodically transmits beacons with a traffic indication message that may be used to indicate that data is ready to be transmitted to the station. The period of time between beacon transmissions may be termed the beacon interval. The station generally utilizes a period of time called the listen interval, corresponding to a plurality of beacon intervals, to coordinate its sleep mode with the access point. Typically, the access point buffers data for the station during the listen interval. Accordingly, the station may awaken from sleep mode to receive the beacon at the end of each listen interval, and if no data is ready to be transmitted, return to sleep mode. As will be appreciated, a longer listen interval may correlate with increased power efficiency because the station may remain in sleep mode for greater periods of time.

Although reducing power consumption may be desirable for any battery-powered station, it may be particularly desirable for a class of extremely low power stations. A concept known as the “Internet of Everything” (IoE) is based on the idea that everyday objects can be readable, recognizable, locatable, addressable, and controllable via the Internet. A wide variety of applications have been identified that may benefit from the availability of low energy and low resource stations that may be associated with such objects, including smart grid and energy management, home and building automation, asset tracking and health and wellness, among others. Although stations used in these applications may still communicate using WLANs, they typically transmit and receive on a more infrequent basis, such as every one or two days or even longer. Further, in many situations, it would be desirable to utilize miniaturized stations capable of operating for years on a single battery source. Accordingly, obtaining the maximum power efficiency possible is a chief design parameter for stations intended for use in the IoE space.

However, existing WLAN systems are not configured to allow stations to maintain a persistent association with an access point while actively communicating only once per day or more infrequently. As a result, conventional wireless communication systems may not realize the full extent of power efficiency that would otherwise be possible by employing stations having extended sleep periods. For example, if the access point disassociates the station during its sleep period, the station must go through a reassociation process which consumes power. Alternatively, the prior art has employed various techniques to avoid disassociation, such as by awakening the station at relatively shorter intervals solely for the purpose of maintaining the association with the access point. Although this technique avoids the need to undergo a reassociation process, it nevertheless represents an excess consumption of power.

Accordingly, what has been needed is a wireless communication system configured to allow stations to remain in sleep mode for extended periods of time. Preferably, the stations may maintain their association with the access point during these extended sleep periods. This specification discloses systems and methods for accomplishing these and other goals.

### SUMMARY OF THE INVENTION

In accordance with the above needs and those that will be mentioned and will become apparent below, this specification discloses a wireless communication system including an access point and a station in association with the access point, wherein the station is configured to transmit keep alive information to the access point regarding a period of time during which the station will be in a low power mode and will not transmit information to or receive information from the access point, wherein the access point is configured to maintain the association with the station for the period of time even when no communications are received from the station during the period of time, and wherein the keep alive information may be configured to allow designation of a period of time greater than 18 hours. Preferably, the access point is configured to set a station idle value for the station corresponding to the keep alive information.

In one aspect, the keep alive information is an enhanced listen interval field in an association management frame transmitted to the access point and is expressed in relation to beacon intervals of the access point, preferably the enhanced listen interval field may be more than 2 bytes.

In another aspect, the keep alive information comprises a listen interval field in an association management frame transmitted to the access point and is expressed in relation to beacon intervals of the access point, wherein the keep alive information may be a scaling designator and wherein the access point is configured to determine the period of time by applying a function to a value corresponding to the listen interval field based upon the scaling designator. In one embodiment, the scaling designator may be an identification of an operating mode of the station such that the access point is configured to apply a function to a value corresponding to the listen interval field on the basis of the operating mode identification. Alternatively, the scaling designator may be the function.

Yet another aspect of the disclosure involves configuring the access point to utilize a first beacon interval and a second beacon interval, wherein the keep alive information may be a listen interval field in an association management frame transmitted to the access point, and wherein the access point is configured to determine the period of time by applying a value corresponding to the listen interval field to the second beacon interval instead of the first beacon interval.

In yet another aspect, the keep alive information may be a keep alive field in an association management frame transmitted to the access point such that the access point is configured to determine the period of time from a value corresponding to the keep alive field.

Further, another embodiment includes keep alive information that may be an enhanced duration field in a Clear-To-Send to Self control frame transmitted to the access point. Preferably, the access point is configured to determine the period of time from a value corresponding to duration field if the value exceeds a threshold and to adjust a network allocation vector if the value does not exceed the threshold. Additionally, in such embodiments, the wireless communication system may include an additional station, wherein the additional station is configured to determine the period of time from a value corresponding to duration field in the transmitted control frame, discard the frame if the value exceeds a threshold and to adjust a network allocation vector if the value does not exceed the threshold.

This disclosure also includes methods for wireless communication between an access point and an associated station, comprising transmitting keep alive information from the station to the access point regarding a period of time during which the station will be in a low power mode and will not transmit information to or receive information from the access point, determining at the access point the period of time corresponding to the keep alive information, and maintaining the association between the access point and the station for the period of time even when no communications are received from the station during the period of time. Preferably, the keep alive information is configured to allow designation of a period of time greater than 18 hours. Also preferably, the method may include setting a station idle value at the access point for the station corresponding to the keep alive information.

Another aspect includes transmitting an enhanced listen interval field in an association management frame that is expressed in relation to beacon intervals of the access point. Alternatively, the station may transmit a listen interval field in an association management frame that is expressed in relation to beacon intervals of the access point, wherein the keep alive information may also include a scaling designator such that determining the period of time comprises applying a function to a value corresponding to the listen interval field based upon the scaling designator. In at least one embodiment, the scaling designator may be an identification of an operating mode of the station and include applying a function to a value corresponding to the listen interval field at the access point on the basis of the operating mode identification. Alternatively, the scaling designator may be the function.

In yet another embodiment, the access point is configured to utilize a first beacon interval and a second beacon interval, such that the method includes transmitting a listen interval field in an association management frame such that determining the period of time may include applying a value corresponding to the listen interval field to the second beacon interval instead of the first beacon interval.

A further aspect includes transmitting a keep alive field in an association management frame such that determining the period of time may include using a value corresponding to the keep alive field.

Yet another aspect is directed to transmitting an enhanced duration field in a Clear-To-Send to Self control frame. Preferably, determining the period of time may include using a value corresponding to the duration field if the value exceeds a threshold and may also include adjusting a network allocation vector at the access point if the value does not exceed the threshold. Additionally, the wireless communication system may include an additional station, such that the method also involves determining at the additional station a value corresponding to the duration field, discarding the control frame if the value exceeds a threshold and adjusting a network allocation vector at the additional station if the value does not exceed the threshold.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 depicts a wireless network including an access point and stations;

FIG. 2 depicts the format of an association request management frame, according to one embodiment of the invention;

FIG. 3 depicts the format of an alternate association request management frame, according to one embodiment of the invention;

FIG. 4 depicts the format of a CTS-to-Self control frame, according to one embodiment of the invention; and

FIG. 5 depicts a routine for processing a CTS-to-Self control frame, according to one embodiment of the invention.

### DETAILED DESCRIPTION OF THE INVENTION

At the outset, it is to be understood that this disclosure is not limited to particularly exemplified materials, architectures, routines, methods or structures as such may, of course, vary. Thus, although a number of such options, similar or equivalent to those described herein, can be used in the practice or embodiments of this disclosure, the preferred materials and methods are described herein.

It is also to be understood that the terminology used herein is for the purpose of describing particular embodiments of this disclosure only and is not intended to be limiting.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

By way of example, and not limitation, computer-usable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), and flash memory or any other medium that can be used to store the desired information.

Further, embodiments are discussed in specific reference to wireless networks. As such, this disclosure is applicable to any suitable wireless communication systems having the necessary characteristics. Although discussed in specific reference to a WLAN featuring an AP and an associated STA, the techniques of this disclosure may be applied to other wireless communication systems or to other network configurations, including ad hoc and peer-to-peer networks.

In the figures, a single block may be described as performing a function or functions; however, in actual practice, the function or functions performed by that block may be performed in a single component or across multiple components, and/or may be performed using hardware, using software, or using a combination of hardware and software. Also, the exemplary wireless network devices may include components other than those shown, including well-known components such as a processor, memory and the like.

The techniques described herein may be implemented in hardware, software, firmware, or any combination thereof. Any features described as modules or components may also be implemented together in an integrated logic device or separately as discrete but interoperable logic devices. If implemented in software, the techniques may be realized at least in part by a tangible computer-readable storage medium comprising instructions that, when executed, performs one or more of the methods described above. The tangible computer-readable data storage medium may form part of a computer program product, which may include packaging materials.

The tangible computer-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates code in the form of instructions or data structures and that can be accessed, read, and/or executed by a computer.

The instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements.

Unless defined otherwise, all technical and scientific terms used herein have the same meaning as commonly understood by one having ordinary skill in the art to which the disclosure pertains.

Further, all publications, patents and patent applications cited herein, whether supra or infra, are hereby incorporated by reference in their entirety.

Finally, as used in this specification and the appended claims, the singular forms “a, “an” and “the” include plural referents unless the content clearly dictates otherwise.

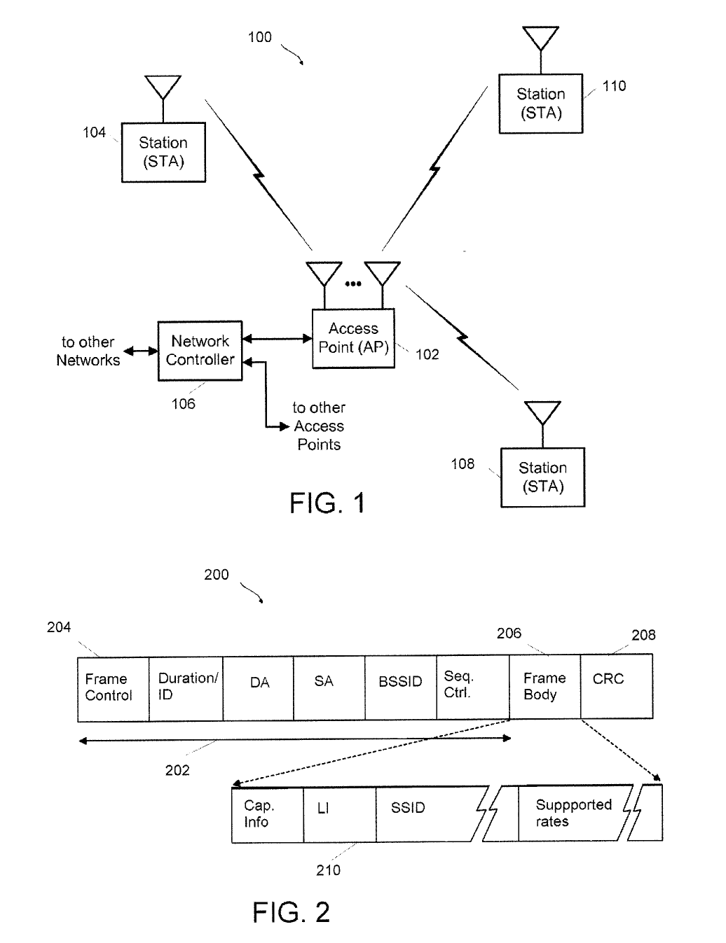

FIG. 1 depicts an exemplary wireless communication system, WLAN 100 which fundamentally includes at least two nodes, AP 102 and associated STA 104. As will be discussed below, AP 102 and STA 104 are configured so that STA 104 transmits keep alive information to AP 102 regarding a scheduled sleep period. During the sleep period, STA 104 may be in a low power mode and correspondingly may not transmit information to or receive information from AP 102. By employing the systems and methods of this specification, AP 102 is configured to maintain the association with STA 104 during the sleep period, even though no communications may be received from STA 104. Preferably, the keep alive information allows STA 104 to designate a sleep period greater than 18 hours, such as 24 or 48 hours or longer as desired. As used herein, the term “extended sleep period” refers to a period of time exceeding 18 hours.

AP 102 is shown connected to network controller 106, such as in a centralized network architecture. Network controller 106 may be coupled to any number of access points, even though only one AP is shown, and provides coordination and control for these access points. Network controller 106 may be a single network entity or a collection of network entities and preferably provides a link to a wide area network (WAN), such as the Internet. For a distributed network, the access points may communicate with one another as needed without the use of network controller 106.

AP 102 periodically transmits a beacon frame on the downlink carrying a preamble and an access point identifier (AP ID) that allows the stations to detect and identify the access point. The time interval between the start of two consecutive beacons is called a target beacon transmit time (TBTT) or a beacon interval. The beacon interval may be fixed or variable and may be set to a suitable duration, e.g., 100 msec. The beacon frame is used by APs to advertise network identification for the stations associated with the AP, the basic service set (BSS) and the related connection capabilities. The beacon frame also includes the time synchronization function information element used to synchronize nodes on the network. Because the beacon frame includes required fields as well as optional vendor-oriented information elements, the size of the frame varies.

A station typically performs association procedures to associate with an access point when the station is first powered up or moves into a new WLAN coverage area. Association refers to the mapping of a station to an access point, which enables the station to receive distribution service. The association allows the distribution service to know which access point to contact for the station. The station attempts to disassociate whenever it leaves the network. The station performs reassociation procedures to “move” a current association from one access point to another access point within an extended service set (ESS). The association, disassociation, and reassociation procedures may be governed by the relevant wireless standard, such as the IEEE 802.11 standards.

A station typically performs negotiation with the access point for various features or attributes such as security, Internet Protocol (IP) address, QoS, flows, power management, etc. The negotiation typically entails exchanging request and response frames between the station and the access point until pertinent parameter values are agreed upon between the station and the access point. Thereafter, the station operates in accordance with the states or context defined by the parameters negotiated with the access point.

As will be appreciated, the exchange of information between the station and access point generally involves the use of management frames, control frames and data frames, each having specific parameters. An example of a media access control (MAC) management association request frame 200 having a format corresponding to IEEE 802.11 standards is depicted in FIG. 2. As shown, frame 200 includes a MAC header 202 of 18 bytes, containing the frame control 204, duration/ID, address and sequence control fields, a variable length frame body 206 and cyclic redundancy check (CRC) field 208 that provides a frame check sequence (FCS) function. Additional fields, such as a high throughput (HT) field (not shown) may be present depending upon the specific standard being employed.

Frame body 206 is shown in greater detail by FIG. 2, and includes fields containing capability information, listen interval (LI) 210, service set identification (SSID) and supported rates. An access point receiving an association request frame will confirm that the capability information, supported rates and SSID match the network parameters before associating with a specific station. The access point may also set a station idle parameter, such as the basic service set maximum idle (BSS Max Idle), for that station. If the access point does not receive communications from the station within the BSS Max Idle, it may assume the station is no longer present in the network and disassociate the station.

As noted above, each access point in a WLAN and its associated stations forms a BSS. A plurality of access points connected by a distribution system forms an extended service set (ESS.) When moving between access points within an ESS, a station may send a reassociation request frame to the new access point, allowing transfer of information regarding the station from the original access point to the new access point. A reassociation request frame may follow the same format as the association request frame 200, except that it may include the address of the original access point in the frame body 206. For the purposes of this disclosure, the term association request frame is used to refer to both association request frames and reassociation request frames.

Of particular relevance to the techniques of this disclosure. LI field 210 may be used by STA 104 to transmit keep alive information to AP 102 regarding a scheduled sleep period, during which STA 104 may be in a low power mode and correspondingly may not transmit information to or receive information from AP 102. By employing the systems and methods of this specification, AP 102 is configured to maintain the association with STA 104 during the sleep period, even though no communications may be received from STA 104.

Conventional IEEE 802.11 standards call for the station to express the scheduled sleep period in terms of beacon intervals. In short, the value of LI 210 indicates the number of beacon intervals the station expects to be in low power mode. However, conventional standards also limit LI 210 to a field of two bytes. As a result, the maximum sleep period that can be reported to the access point under these conditions is inherently limited by the maximum value represented by two bytes multiplied by the beacon interval.

As discussed above, the beacon interval may vary, having a value between 20 msec and 1024 msec, and may typically have a default value of 100 msec. The maximum value that may be expressed using two bytes is the hexadecimal FF which is equivalent to 65,535. Accordingly, even if the maximum beacon interval is employed, the longest sleep period that may be indicated to the access point is 65,535*1024 msec, or 18 hours, using the conventional IEEE 802.11 protocols. In many practical applications, setting the beacon interval to the maximum value may result in a degradation of other aspects of network performance. When a more generally applicable beacon interval of 100 msec is employed, the maximum sleep period that may be indicated is less than 2 hours.

In view of the discussion above, conventional standards that limit the sleep period that a station may indicate to the access point results in an undesirable consumption of power for stations having operational uses that would otherwise allow extended sleep periods of longer than 18 hours, preferably 24 to 48 hours, or more. As noted, the inability to signal longer sleep periods may require more frequent awakening in order to communicate with the access point and keep the association alive or may require a new association process upon awakening. The techniques of this disclosure allow STA 104 to inform AP 102 of extended sleep periods using keep alive information.

In a first aspect, STA 104 and AP 102 are configured to generate and process an enhanced LI 210 field of more than 2 bytes, for example, 3 or 4 bytes. Even at beacon intervals of 100 msec, the use of a four byte LI 210 allows STA 104 to indicate a sleep period in excess of ten years. For purposes of compatibility with legacy IEEE 802.11 devices, any suitable field or information element of a frame sent by STA 104 to AP 102 may include differentiation information. Referring back to FIG. 1, an additional legacy STA 108 is shown. For example, frame control field 204 includes a type and subtype field of two and four bits, respectively. These may be used to distinguish an association frame 200 having a four byte LI 210 sent from STA 104 from an association frame having a two byte LI as dictated by current IEEE 802.11 standards that may be sent by STA 108.

Alternatively, the keep alive information transmitted by STA 104 may include a conventional two byte LI 210 in conjunction with a scaling designator. Preferably, the scaling designator is associated with a scaling function that is employed by AP 102 to adjust the sleep period determined for STA 104. The scaling designator may be the scaling function itself or may be an identifier that allows AP 102 to select an appropriate scaling function stored by the AP. The scaling function may be linear and comprise a suitable coefficient, such as 10, or may be exponential as desired. In a further aspect, the scaling designator may represent the operational mode of STA 104. For example, a scaling function may be selected based upon the wireless protocol employed STA 104 or based upon a use designation, such as if STA 104 is operating as a sensor. The scaling designator also may be transmitted by any suitable field or information element of a frame sent by STA 104 to AP 102, such as the type and subtype elements of frame control field 204. In one implementation, one or more of the bits of LI 210 may be reduced to 14 or 15 bits to allow use of the residual 1 or 2 bits to communicate the scaling designator.

In other embodiments, wireless protocols supporting the definition of more than one beacon interval may be employed. Specifically, a first, relatively short beacon interval may be defined for use with general purpose stations while a second, relatively long beacon interval may be defined for use with low power, extended sleep stations. Accordingly, the keep alive information transmitted by STA 104 to AP 102 may include a designation of which beacon interval to use when determining the listen interval.

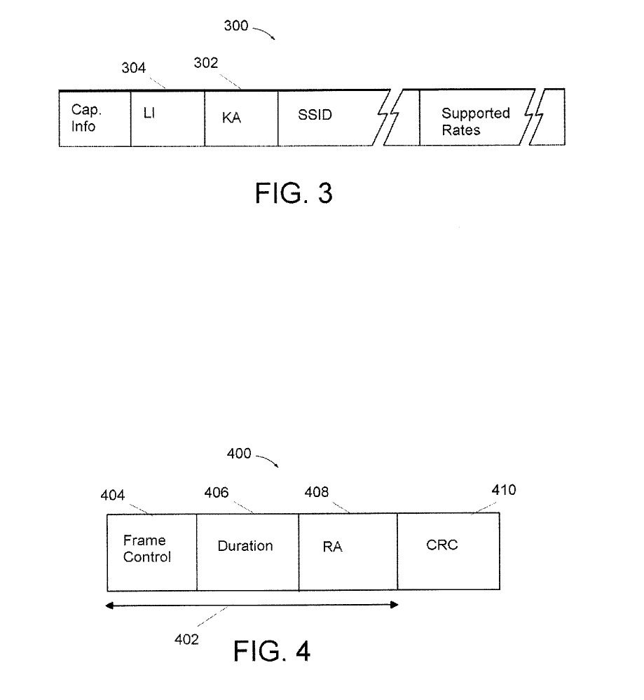

Yet another aspect of this disclosure is directed to the use of frame employing a separate keep alive information element. FIG. 3 depicts a suitable format for a frame body 300 of an association request frame featuring keep alive (KA) information element 302. As depicted, KA 302 is positioned immediately following LI 304 in frame body 300, but KA 302 may be located at any suitable position within frame body as desired. Further, KA 302 may have a length of four bytes and be used in conjunction with the beacon interval to allow AP 102 to determine the scheduled sleep period for STA 104. Alternatively, KA 302 may be expressed in any suitable units, either relative to a time period defined by AP 102 or STA 104, or to an absolute value. If AP 102 is configured to interpret KA 302 in units of minutes, for example, KA 302 may require only two bytes while still designating sleep periods in excess of a month.

In a still further aspect, the keep alive information may be transmitted by STA 104 to AP 102 using a different type of frame. For example, IEEE 802.11 standards call for the use of control frames to negotiate periods of time during which other network nodes suspend transmission to minimize or avoid collisions. Generally, one node may send a request to send (RTS) frame indicating a duration corresponding to a desired transmission time. Upon receipt of an RTS frame, a node may reply with a clear to send (CTS) confirming that the indicated transmission will occur. Other networks nodes receiving either the RTS or CTS frame may then adjust their network allocation vector (NAV) in order to avoid transmitting during the period of time designated for the transmission. Further, a CTS-to-Self frame may be transmitted by a network node to unilaterally reserve a period of time. FIG. 4 depicts the format of a CTS-to-Self frame that may be configured to transmit keep alive information.

As shown, CTS-to-Self frame 400 includes a MAC header 402, with frame control 404, duration field 406 and address field 408, terminated by CRC field 410. The duration field 406 is limited to two bytes under current IEEE 802.11 standards and may be expressed in time units (TU) that are 1024 msec long. As noted above, duration field 406 is conventionally used by nodes receiving CTS-to-Self frame 400 to adjust their NAV. As a result, the value of duration field 406 is typically relatively small as it indicates a period of time during which all nodes within range are intended to suspend transmission.

Using the techniques of this disclosure, AP 102 and STA 104 may be configured to use duration field 406 for keep alive information to indicate the scheduled sleep period of STA 104. In one embodiment, a new CTS-to-Self frame is defined such that enhanced duration field 406 is four bytes in length, allowing this field to express significant periods of time, well in excess of 18 hours. AP 102 may be configured to interpret duration field 406 as corresponding to the scheduled sleep time based upon the use of any suitable signaling information in CTS-to-Self frame 400.

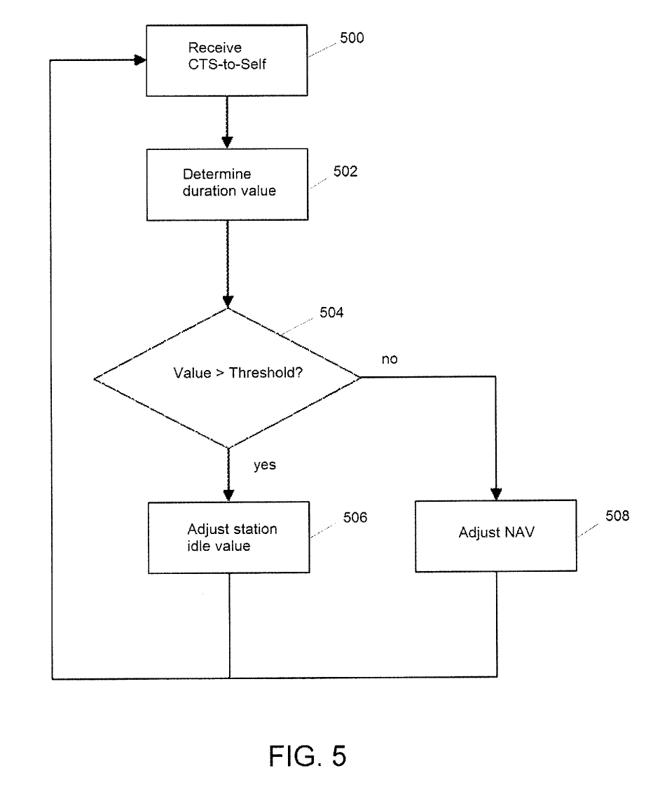

Alternatively, since periods of time expressed for a scheduled sleep time are considerably greater of a length as compared to the periods of time that the transmission medium would be reserved, AP 102 may be configured to apply a suitable threshold. An example routine for this technique is depicted in FIG. 5. In step 500, AP 102 receives CTS-to-Self frame 400 and extracts the value corresponding to duration field 406 in step 502. The value is compared to a suitable threshold, such as one minute, in step 504. If the value exceeds the threshold, AP 102 interprets duration field 406 as corresponding to the scheduled sleep period of STA 104 and adjusts the station idle value associated with STA 104 appropriately in step 506. If the value does not exceed the threshold, AP 102 interprets duration field 406 as a conventional reservation of the transmission medium and adjusts its NAV appropriately in step 508. In either situation, the process returns to step 500 to receive another CTS-to-Self frame.

In one embodiment, the routine of FIG. 5 may be applied to CTS-to-Self frames having four byte duration fields 406. In other embodiments, a suitable threshold may be established within the range of values represented by two bytes. However, the use of two bytes still limits the maximum sleep period that may be indicated directly using TUs to 18 hours. As such, it may be preferable to apply a suitable scaling function once AP 102 makes the determination that duration field 406 applies to the scheduled sleep period of STA 104 in the manner discussed above so as to allow STA 104 to indicate scheduled sleep periods in excess of 18 hours.

Further, in the noted embodiments employing a CTS-to-Self frame to transmit keep alive information using duration field 406, other stations are preferably configured to properly distinguish between the possible types of information. For example, as shown in FIG. 1, an additional STA 110 may be within range of STA 104 when it transmits CTS-to-Self frame 400. STA 110 is preferably configured to discard CTS-to-Self frame 400 when duration field 406 is in excess of a suitable threshold so that it does not incorrectly adjust its NAV value.

Described herein are presently preferred embodiments. However, one skilled in the art that pertains to the present invention will understand that the principles of this disclosure can be extended easily with appropriate modification.

What is claimed is:

1. A wireless communication system comprising an access point and a station in association with the access point, wherein the station is configured to transmit keep alive information to the access point regarding a period of time during which the station will be in a low power mode and will not transmit information to or receive information from the access point, wherein the access point is configured to maintain the association with the station for the period of time even when no communications are received from the station during the period of time, and wherein the keep alive information is configured to allow designation of a period of time greater than 18 hours.

2. The wireless communications system of claim 1, wherein the access point is configured to set a station idle value for the station corresponding to the keep alive information.

3. The wireless communications system of claim 1, wherein the keep alive information comprises an enhanced listen interval field in an association management frame transmitted to the access point and is expressed in relation to beacon intervals of the access point.

4. The wire communications system of claim 1, wherein the enhanced listen interval field comprises more than 2 bytes.

5. The wireless communications system of claim 1, wherein the keep alive information comprises a listen interval field in an association management frame transmitted to the access point and is expressed in relation to beacon intervals of the access point, wherein the keep alive information further comprises a scaling designator and wherein the access point is configured to determine the period of time by applying a function to a value corresponding to the listen interval field based upon the scaling designator.

6. The wireless communications system of claim 5, wherein the scaling designator comprises an identification of an operating mode of the station and wherein the access point is configured to apply a function to a value corresponding to the listen interval field on the basis of the operating mode identification.

7. The wireless communications system of claim 5, wherein the scaling designator comprises the function.

8. The wireless communications system of claim 1, wherein the access point is configured to utilize a first beacon interval and a second beacon interval, wherein the keep alive information comprises a listen interval field in an association management frame transmitted to the access point, and wherein the access point is configured to determine the period of time by applying a value corresponding to the listen interval field to the second beacon interval instead of the first beacon interval.

9. The wireless communications system of claim 1, wherein the keep alive information comprises a keep alive field in an association management frame transmitted to the access point and wherein the access point is configured to determine the period of time from a value corresponding to the keep alive field.

10. The wireless communications system of claim 9, wherein the keep alive information comprises an enhanced duration field in a Clear-To-Send to Self control frame transmitted to the access point.

11. The wireless communications system of claim 9, wherein the access point is configured to determine the period of time from a value corresponding to duration field if the value exceeds a threshold and to adjust a network allocation vector if the value does not exceed the threshold.

12. The wireless communication system of claim 11, further comprising an additional station, wherein the additional station is configured to determine the period of time from a value corresponding to duration field in the transmitted control frame, to discard the frame if the value exceeds a threshold and to adjust a network allocation vector if the value does not exceed the threshold.

13. A method for wireless communication between an access point and an associated station, comprising:
a) transmitting keep alive information from the station to the access point regarding a period of time during which the station will be in a low power mode and will not transmit information to or receive information from the access point;
b) determining at the access point the period of time corresponding to the keep alive information; and
c) maintaining the association between the access point and the station for the period of time even when no communications are received from the station during the period of time;
wherein the keep alive information is configured to allow designation of a period of time greater than 18 hours.

14. The method of claim 13, further comprising setting a station idle value at the access point for the station corresponding to the keep alive information.

15. The method of claim 13, wherein transmitting keep alive information comprises transmitting an enhanced listen interval field in an association management frame that is expressed in relation to beacon intervals of the access point.

16. The method of claim 13, wherein transmitting keep alive information comprises transmitting a listen interval field in an association management frame that is expressed in relation to beacon intervals of the access point, wherein the keep alive information further comprises a scaling designator and wherein determining the period of time comprises applying a function to a value corresponding to the listen interval field based upon the scaling designator.

17. The method of claim 16, wherein the scaling designator comprises an identification of an operating mode of the station and further comprising applying a function to a value corresponding to the listen interval field at the access point on the basis of the operating mode identification.

18. The method of claim 16, wherein the scaling designator comprises the function.

19. The method of claim 13, wherein the access point is configured to utilize a first beacon interval and a second beacon interval, wherein transmitting keep alive information comprises transmitting a listen interval field in an association management frame, and wherein determining the period of time comprises applying a value corresponding to the listen interval field to the second beacon interval instead of the first beacon interval.

20. The method of claim 13, wherein transmitting keep alive information comprises transmitting a keep alive field in an association management frame and wherein determining the period of time comprises using a value corresponding to the keep alive field.

21. The method of claim 13, wherein transmitting keep alive information comprises transmitting an enhanced duration field in a Clear-To-Send to Self control frame.

22. The method of claim 21, wherein determining the period of time comprises using a value corresponding to the duration field if the value exceeds a threshold and further comprising adjusting a network allocation vector at the access point if the value does not exceed the threshold.

23. The method of claim 22, wherein the wireless communication system further comprises an additional station, further comprising determining at the additional station a value corresponding to the duration field, discarding the control frame if the value exceeds a threshold and adjusting a network allocation vector at the additional station if the value does not exceed the threshold.
